(19) United States
(12) Patent Application Publication
(10) Pub. No.: US 2011/0223291 A1
(43) Pub. Date: Sep. 15, 2011

(54) NOVELTY CANDY DISPENSER 2

(76) Inventor: Jules R. Shecter, Boca Raton, FL (US)

(21) Appl. No.: 13/002,297

(22) PCT Filed: Dec. 24, 2009
(86) PCT No.: PCT/US09/06711

§ 371 Date: Dec. 30, 2010

(51) Int. Cl. A23G 3/34; A23G 3/50

(52) U.S. Cl. 426/104; 426/115

(57) ABSTRACT

A candy food product comprises a candy pop having a hard candy rod formed and supported at a support base, and a dispenser shaped as a personal electronic device for storing a plurality of confectionary powders in a plurality of confectionary compartments. A lid selectively movable between an open and closed position sealingly engages the dispenser. A receptacle is formed in the dispenser proximate to the confectionary compartments and receives the candy pop therein.

### CROSS-CONNECTION WITH RELATED CASES

This application is a continuation-in-part application of U.S. application Ser. No. 12/217,459, filed Jul. 2, 2008, the entire contents of which is incorporated herein by reference.

### BACKGROUND OF THE INVENTION

1. Field of the Invention

The present invention relates to a novelty candy dispenser and more particularly, to a hard candy pop that is removably received in an imitation electronic device containing multiple confectionary powders so that the candy pop can be dipped in a choice of the powders and thus be consumed in conjunction with the confectionary powder.

2. Discussion of the Related Art

Lollipops and other hard candy pops have been traditionally placed on a stick to permit repeated removal and placement of the candy within one's mouth without having to touch the candy, thereby providing a convenient and sanitary means of consuming the candy product. Over the years, various hard candy pops have been produced in a multitude of shapes, sizes, and flavors. Additionally, candy pops have been formed around various supporting structures to provide additional novelty aspects to make the product more desirable.

These and other hard candy pops and holder devices provide a fun alternative to the traditional candy pop. In particular, children are attracted to candy pops and holders that incorporate some novelty aspect in addition to the flavor of the hard candy of the pop. For this reason, many children will choose a candy pop that incorporates a novelty feature over the more traditional forms of candy, such as candy pops on a plain stick.

While various configurations of candy pops include different sizes, shapes, single flavors, multi-flavors, and holders as novelty features to increase desire for the pops, probably the most important feature is flavor. Candy pops being essentially hard candy are primarily sugar and thus sweet. However, desired flavors are more than merely the sweetness of sugar, but also include recognizable flavors such as fruits to mimic naturally tasting foods we encounter in our nutritional intake. There are some favored combinations that include distinct flavor layers and textures as opposed to a homogenous hard candy incorporating all flavors into the hard candy such as caramel and apples or strawberries and chocolate. One such combination is a flavored hard candy pop that can be dipped into confectionary powder of a second flavor.

Thus, what is desired is a novelty candy dispenser that incorporates both a hard candy flavored pop and multiple flavored confectionary powders in which the flavored pop can be dipped.

### SUMMARY OF THE INVENTION

One aspect of the present invention is directed to a candy food dispenser including a candy pop having a confectionary product formed and supported by a non-edible holder and a case shaped as a personal electronics device for storing a plurality of flavors of a confectionary powder. The case further contains a plurality of containers for holding the confectionary powders and has a closed bottom and sides and an open top. A lid shaped as an element of the toy sealingly engages with the open top of the containers. A receptacle receiving the candy pop is located in the case and located proximate to the other containers. As such, a candy dispenser is provided in which the flavor of an edible candy pop can be enhanced or changed by the selected one of a number of different confectionary powders.

These and other advantages of the invention will be further understood and appreciated by those skilled in the art by reference to the following written specification, claims and appended drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a front perspective view of a candy dispenser for a confectionary powder that includes a candy pop, with some parts cut away to show the powder, embodying the present invention according to a first embodiment thereof;

FIG. 2 is a partially exploded front perspective view of the dispenser of FIG. 1 illustrating an associated candy pop extracted therefrom;

FIG. 3 is a front perspective view, with some parts cut away, of the dispenser of FIG. 1 shown in an operative mode illustrating the associated candy pop being dipped in a compartment of confectionary powder;

FIG. 4 is a rear perspective view of the dispenser of FIG. 1 illustrating an optional belt clip.

FIG. 5 is a partially exploded front perspective view of a candy dispenser for a confectionary powder that includes a candy pop in accordance with a third embodiment of the present invention.

FIG. 6 is a front elevational view of the candy dispenser shown in FIG. 5 in which the candy pop is inserted in a storage compartment therefor;

FIG. 7 is a side elevational view of the candy dispenser shown in FIG. 5;

FIG. 8 is a cross-sectional view taken along line 8-8 of FIG. 6; and

FIG. 9 is a cross-sectional view that is the same as FIG. 8 except that shows the candy pop inserted into a receptacle of the dispenser.

FIG. 10 is a cross-sectional view taken along line 10-10 of FIG. 6;

### DETAILED DESCRIPTION OF THE PREFERRED EMBODIMENTS

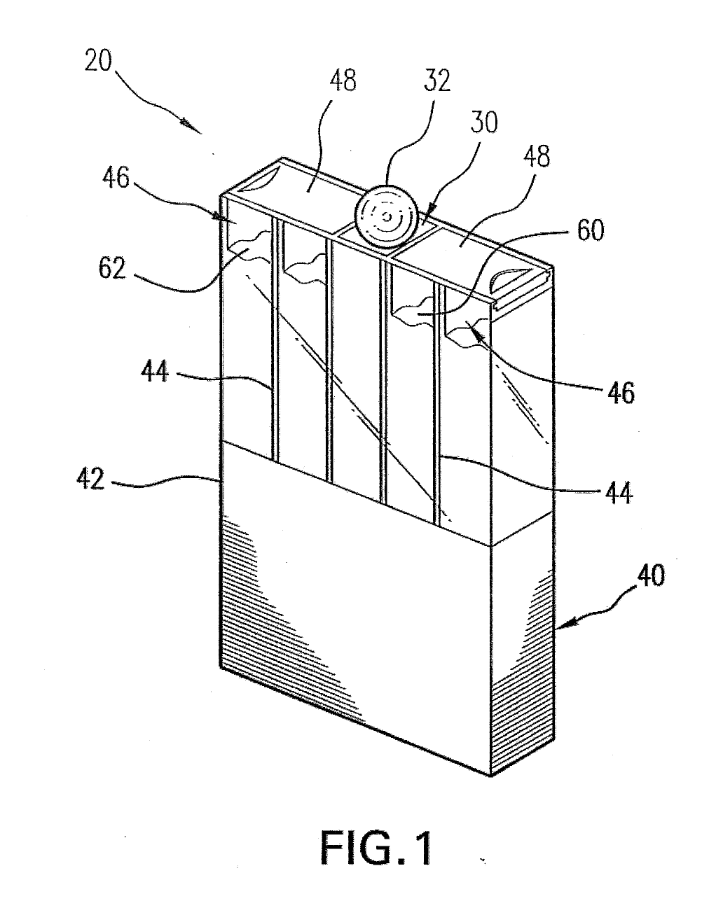

Like reference numerals refer to like parts throughout the several views of the drawings. For purposes of description herein, the terms “upper”, “lower”, “left”, “rear”, “right”, “front”, “vertical”, “horizontal”, and derivatives thereof shall relate to the invention as oriented in FIG. 1. However, it is to be understood that the invention may assume various alternative orientations and step sequences, except where expressly specified to the contrary.

Turning to the drawings, FIG. 1 shows a candy food product 20 comprising a candy pop 30 that is removably retained in a dispenser 40 that is typically shaped and sized to mimic a personal electronic device such as an MP3 player and is one of the preferred embodiments of the present invention and illustrates its various components. Optionally, an exterior of dispenser 40 can have applied thereon a decal or applique (not shown) having the printed image of a personal electronic device thereon to further the resemblance of food product 20 to that of a personal electronic device.

Referring to FIGS. 1-3 candy food product 20 includes a dispenser 40 having an external shape resembling the form of a personal electronic device. Dispenser 40 has a hollow case 42 typically assuming a rectilinear form as shown wherein the width dimension is substantially less than the length and height dimensions. Case 42 has an interior cavity therein and a plurality of dividers 44 regularly spaced internal in the cavity along the length of case 42 separating an interior of case 42 into a plurality of confectionary compartments or containers 46. Each confectionary compartment 46 is typically filled with a flavored confectionary powder 60, 62 of differing desired flavors.

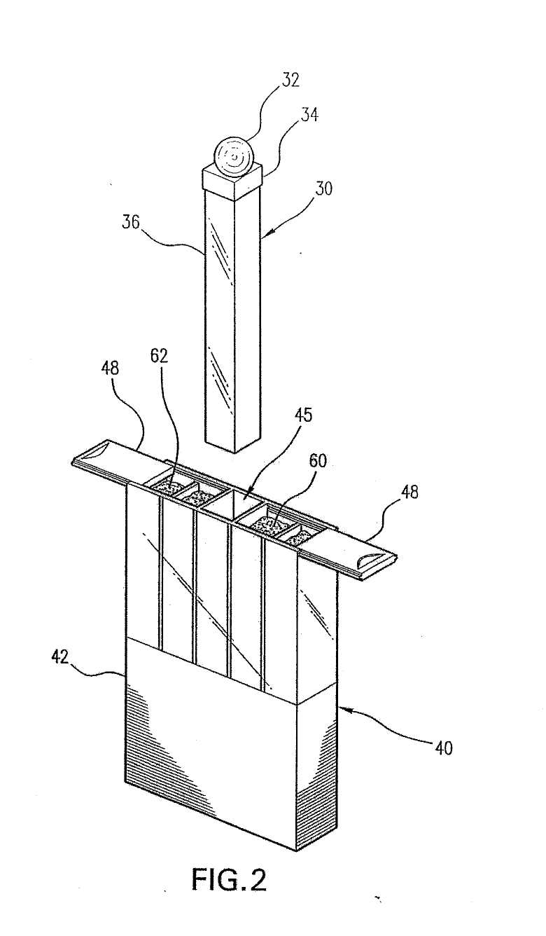

Thus, the multiple confectionary compartments 46 can contain a variety of different flavors of confectionary powders such as sour apple 60 in one compartment 46 and strawberry 62 in a different compartment 46 without the intermingling of flavors. Case 42 includes lids 48 which are selectively moveable between a closed position as shown in FIG. 1 and an open position as shown in FIG. 2 to seal confectionary compartments 46 thereby preventing confectionary powders 60, 62 from inadvertent spillage or contamination. Lids 48 may be slidably retained in a well known manner as shown in FIG. 2 or may alternately be hinged at one end for hinged opening (not shown) also in a well known manner.

As most clearly shown in FIG. 2, a candy pop 30 is shaped for storage in a central receptacle 45. While receptacle 45 is illustrated as being centrally located within case 42, those practiced in the art will readily recognize that dispenser 40 can be configured to house candy pop 30 in any location of receptacle 45 or confectionary compartments 46 by the selective positioning of lids 48. Candy pop 30 includes a support base 34 having a hard candy rod 36 extending downward therefrom and a handle 32 on an opposite end of support base 34 for grasping by a user. Hard candy rod 36 and support base are shaped to closely fit within receptacle 45 for storage and to prevent contamination from dirt and other contaminants when the product is not being consumed by the user.

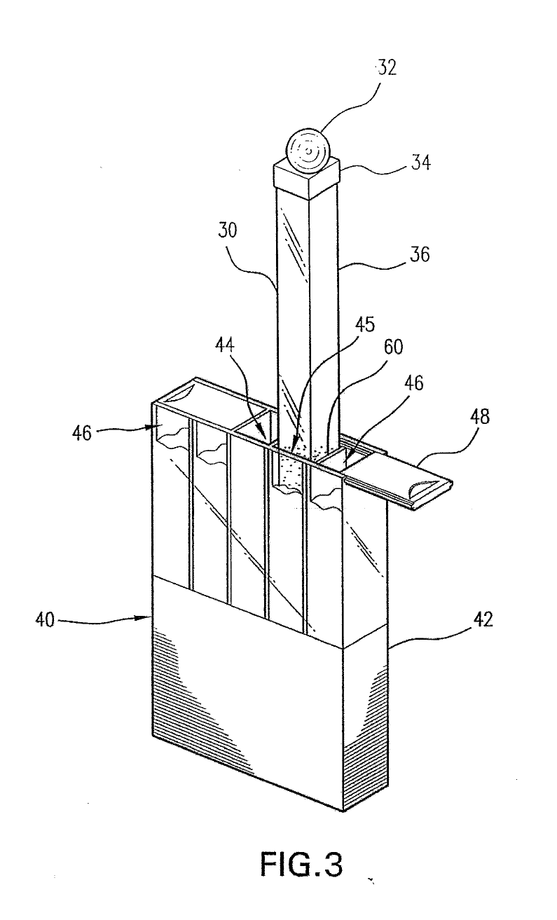

In use, and as shown most clearly in FIG. 3, a user will extract candy pop vertically from receptacle 45 and can then begin to lick or suck on the free end of the hard candy rod extending from support base 34. To enhance the flavor of hard candy rod 36, the user can open one of lids 48 to gain access to one or more confectionary compartments 46. The free end of candy rod 36 can then be inserted into the desired compartment 46 to contact the confectionary powder 60 therein. A quantity of confectionary powder 60 will then adhere to candy rod 36 at which time the user can extract candy rod 36 from compartment 46 and again lick or suck on the free end of candy rod 36 to enjoy the combined flavors of candy rod 36 and confectionary powder 60. Alternatively, the user can also sequentially insert the free end of candy rod 36 in multiple confectionary compartments 46 to adhere more than one flavor of confectionary powders 60,62 to candy rod 36 prior to consuming. When the user has satiated his or her desire for consumption of the candy, candy pop 30 can then be reinserted into receptacle 45 and lids 48 closed until the user again desires to be treated to candy pop 30 and confectionary powders 60, 62.

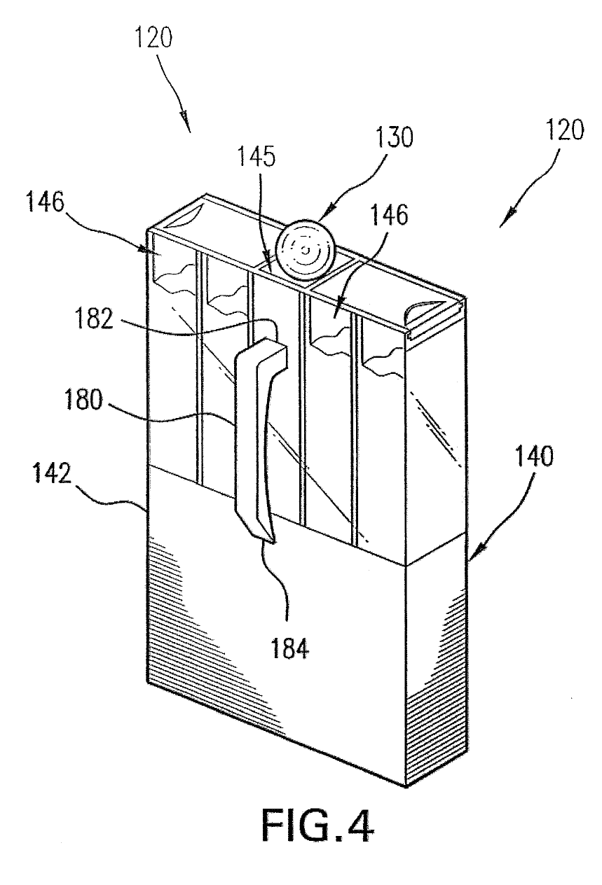

Referring now to FIG. 4, a second embodiment candy product 120 is shown which is similar to candy product 20 and comprises a dispenser 140 in which are formed a plurality of confectionary compartments or containers 146 for retaining different flavored confectionary powders and one receptacle 145 in which is retained a candy pop 130. Dispenser 140 includes a case 142 to which is affixed a clip 180. Clip 180 has a top end 182 that is affixed to a side of case 142 and a bottom end 184 that abuts the side of case 142 but is not affixed thereto. Clip 180 has a degree of resiliency such that bottom end can be marginally displaced from case 142 to receive between end 184 and case 142 an item such as a belt or an item of clothing such that candy product 120 can be secured to a users belt or item of clothing to prevent candy product 120 from being inadvertently lost from a clothing pocket in which it is stored or to permit the prominent display of candy product 120 by the user.

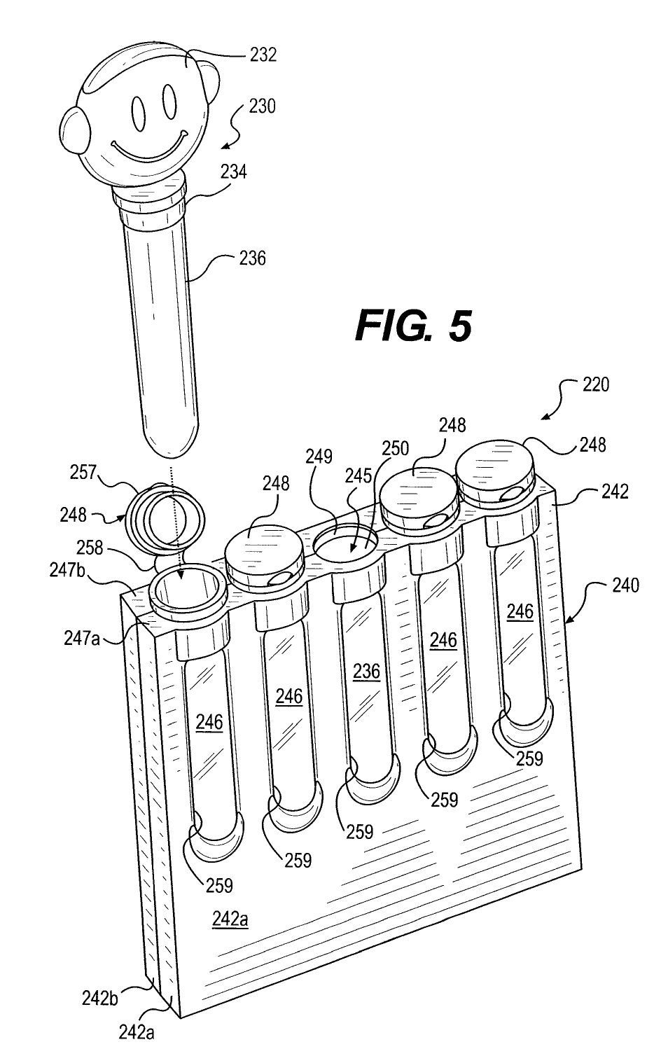

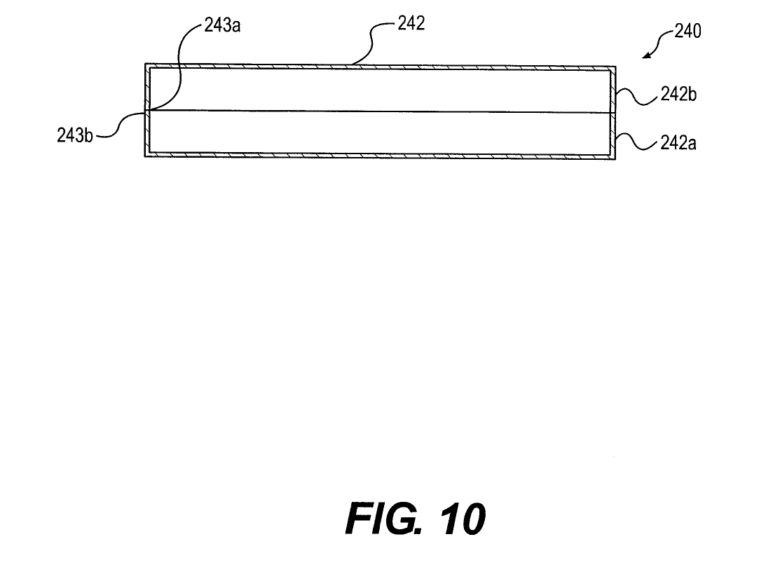

Referring now to FIGS. 5-10, a third embodiment of a candy product 220 in accordance with the present invention is shown. Candy product 220 has some similarities to candy products 20 and 120 and includes a removable candy pop 230 and, in elevational view, a rectangular dispenser 240.

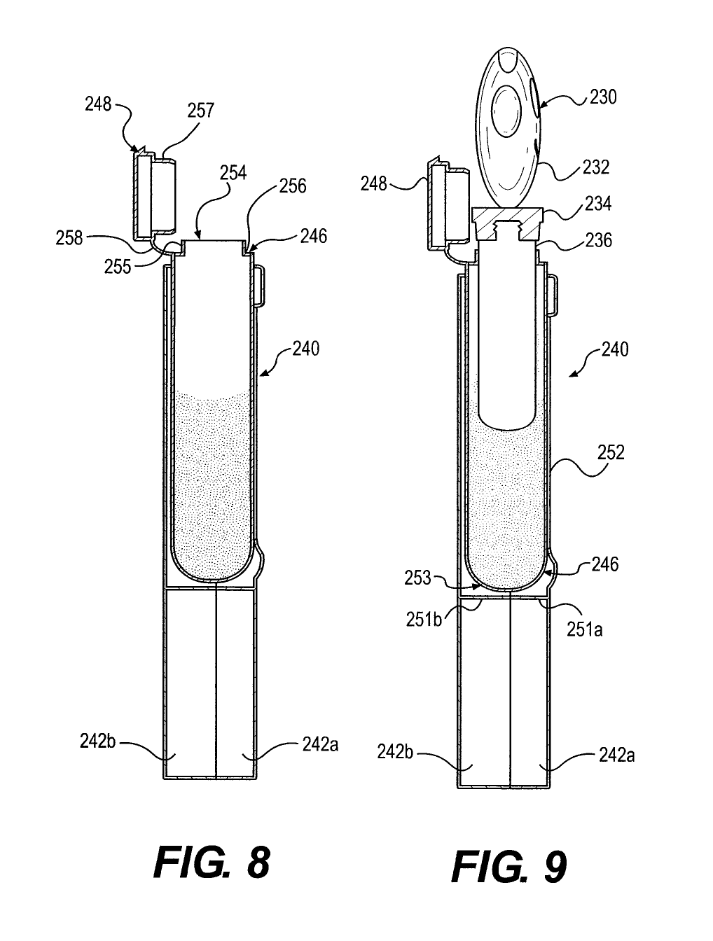

Dispenser 240 is made of a conventional plastic material and is comprised of a case 242. Case 242 is a rectangular parallelopiped and has a hollow front half shell portion 242a that has a “C” shaped cross-section with a peripheral outer edge 243a, and has a corresponding, mating hollow rear half shell portion 242b, that also has a “C” shaped cross-section with a peripheral outer edge 243b. Shell portions 242a and 242b are fixedly connected together by means such as an adhesive or a welding along their respective outer edges 243a and 243b. A top portion 247a of front shell portion 242a and a top portion 247b of rear shell portion 242b have 5 semi-circular cutouts 249 which form circular holes or cutouts 250 of case 242 when shell portions 242a and 242b are fixedly connected together. As shown in FIGS. 8 and 9, each shell portion 242a and 242b has a shelf 251a and 251b, respectively, which is located about two thirds of the way down from the respective top portions 247a and 247b. Shelves 251a and 251b horizontally extend completely across the respective shell portions and are attached to the sides thereof. When shell portions 242a and 242b are fixedly mounted together, shelves 249a and 249b abut each other. If desired, shelves 249a and 249b can be fixedly connected together with a means such as an adhesive. As will be seen below, the vertical position of shelves 251a and 251b within case 242 depend upon other constraints of dispenser 240.

Case 242 has a plurality of confectionary compartments or containers therein for containing and for retaining different flavored confectionary powders. Such powders are conventional and can include for example sour flavorings of grape, strawberry, lemon, lime, etc. In the embodiment of FIGS. 1-3, the compartments or containers are provided by including a plurality of longitudenly extending dividers mounted spaced apart inside case 42. However, in this embodiment it is difficult to vary or control the amount of powder in each compartment and to have different volumes inside each compartment.

In the embodiment of FIGS. 5-10 these difficulties are overcome by providing a plurality of containers that are separate, elongate cylindrical hollow tubes 246 that are mounted in case 242. Each tube 246 is made of a transparent plastic, such as by extrusion or other molding, and has a cylindrical enclosing wall or body 252, a closed bottom 253, and an open top 254. A ledge 256 resulting from a top portion 255 of tube 246 having a slightly smaller outer diameter than the outer diameter of tube body 252 is engaged by the outer wall defining hole 250. As a result of the resiliency of the outer wall, tube 246 is snap fitted and retained in case 242.

Attached to each tube 246 is a cap 248 comprised of a cover 257 and a flexible hinge 258 that is made of a flexible plastic and is fixedly attached at one end to cover 257 and at the other end to a portion of tube top 244. Cover 257 has a diameter and wall thickness so as to be removably, sealingly insertable into tube top 254. Thus when inserted into a tube 246, cap 248 prevents the spillage or loss of any confectionary item contained in tube 246. In addition, cap 248 prevents moisture or other contaminants from entering tube 246. Although tubes 246 are depicted in this embodiment as being cylindrical with a circular cross-section, they can be of any other shape such as rectangular with a square or rectangular cross-section; an elliptical cross-section, or a diamond cross-section. In addition, although each tube 246 is shown as being identical in shape and size with the others, each tube can have a different shape and/or size.

In a first particular embodiment, tubes 246 are fixedly mounted in case 242 using means such as an adhesive or welding. In a second particular embodiment tubes 246 are removably mounted within case 242 so that when empty, they can be replaced or so that a different flavor powder can be provided. Tubes 246 have an outer diameter so that they can be inserted and snugly mounted into a corresponding hole 250. Tubes 246 have a length, and/or shelves 251 a and 251 b have a position within case 242, such that tubes 246 extend from the top of case 242 to and are supported by shelves 251a and 251b. If desired, tubes 242 can be fixedly attached to shelves 251a and 251b and shell portions 242a and 242b with a means such as an adhesive.

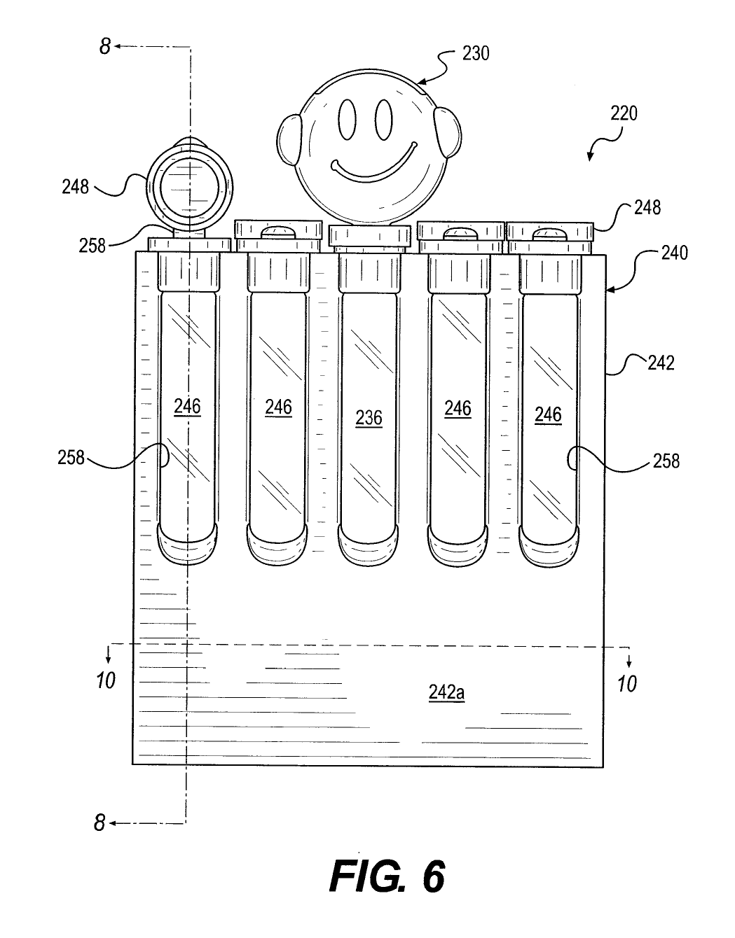

As most clearly shown in FIGS. 5 and 9, a candy pop 230 is shaped for storage in a receptacle 245 in case 242. Receptacle 245 is illustrated in FIGS. 5 and 6 as being centrally located within case 242 and in line with tubes 246. However, those practiced in the art will readily recognize that dispenser 240 can be configured to locate receptacle 245, and thereby house candy pop 230, in any location of case 242.

Candy pop 230 is elongate and includes a handle 232 at its upper end and a support base 234 below handle 232 and integral therewith. Mounted onto support base 234 is a solid hard candy cylindrical rod 236 extending downward therefrom. Handle 232 can have any desirable, ornamental or decorative shape and coloring. In the embodiment shown in FIG. 5, handle 232 has the shape and decorative features of a happy face with protruding ears and distinctive vertically oval eyes. Handle 232 is used for extracting candy pop 230 from its receptacle 245 or for holding candy pop 230. Base 234 is shaped to closely fit within receptacle 245 for storage and to prevent contamination from dirt and other contaminants when the candy rod 236 is not being consumed by the user.

As seen in FIGS. 5 and 6, front shell portion 242a has a plurality of horizontally spaced apart elongate cutouts 259 completely through front shell portion 242a in a plurality of locations such that when a tube 246 or candy pop rod 236 is mounted or inserted in case 242 most of the length of such tube 246 or candy pop 230 is visible therethrough.

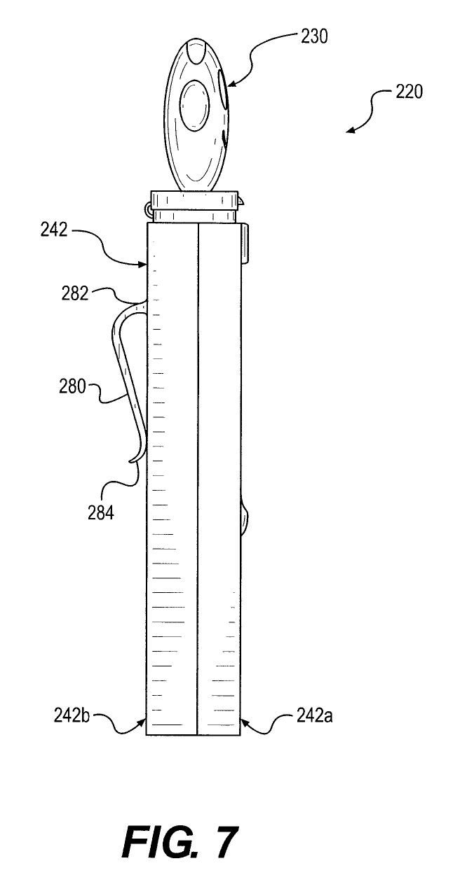

Dispenser 240, as shown in FIG. 7 includes a clip 280 that is affixed to rear shell portion 242b of case 242. Clip 280 has a top end 282 that is fixedly affixed to a side of rear shell portion 242b of case 242 and a bottom end 284 that abuts the side of case 242 but is not affixed thereto. Clip 280 has a degree of resiliency such that bottom end 284 can be marginally displaced from case 242 to receive between end 284 and the back of rear shell portion 242 an item such as a belt or an item of clothing such that candy dispenser 240 can be secured to a users belt or item of clothing to prevent dispenser 240 from being inadvertently lost from a clothing pocket in which it is stored or to permit the prominent display of candy product 120 by the user.

In the foregoing description those skilled in the art will readily appreciate that modifications may be made to the invention without departing from the concepts disclosed herein. Such modifications are to be considered as included in the following claims, unless these claims expressly state otherwise.

While the present invention has been shown and described in accordance with preferred and practical embodiments thereof, it is recognized that departures from the instant disclosure are fully contemplated within the spirit and scope of the invention. Hence, specific dimensions and other physical characteristics relating to the embodiments disclosed herein are not to be considered as limiting, unless the claims expressly state otherwise.

I claim:

1. A candy food product comprising:
an elongate candy pop having a base and having a rod portion attached to said base and extending therefrom, said rod portion made of a confectionary produce; and
a dispenser, said dispenser comprised of
a hollow case having a plurality of confectionary containers therein for containing a variety of confectionary powders, each said confectionary compartment having an open top portion thereof for access to the confectionary powders;
one or more lids covering said confectionary containers and selectively movable between an open and closed position for permitting access to an interior of said confectionary containers and for sealing said confectionary containers to prevent spillage of any product therein; and
a receptacle in said dispenser located proximate to said confectionary compartments for removably receiving and storing said candy pop therein.

2. The candy food product as claimed in claim 1 wherein said dispenser has an outer appearance suggestive of an personal electronic device.

3. The candy food product as claimed in claim 1 wherein said receptacle is centrally positioned in said dispenser.

4. The candy food product as claimed in claim 1 wherein said confectionary containers contain a plurality of flavored confectionary powders, each said container containing a different uniquely flavored confectionary powder.

5. The candy food product as claimed in claim 1 wherein said case is a rectangular parallelopiped, and said containers are lineally aligned in said case.

6. The candy food product as claimed in claim 5 wherein there are an even number of containers;
and said receptacle is centrally positioned between and lineally aligned with said containers in said case.

7. The candy food product as claimed in claim 5 wherein said containers are compartments in said case that are defined by a plurality of separating dividers.

8. The candy food product as claimed in claim 5 wherein said containers are hollow tubes mounted in said case and having a side, a bottom and an open top.

9. The candy food product as claimed in claim 8 wherein said tubes are cylindrical.

10. The candy food product as claimed in claim 8 and further including a cap and a flexible hinge having two ends, said hinge being attached at one end thereof to a corresponding ones of said tubes and attached at the other end thereof to said cap, said cap having a shape and size such that said cap can be removably inserted in said open top and such that said cap seals said tube.

11. The candy food product as claimed in claim 5 wherein one side of said case has a plurality of lineally aligned elongate cutouts in a plurality of locations such that most of the length of said tubes or said candy pop is visible therethrough.

12. The candy food product as claimed in claim 1 and further including a clip mounted on a back side of said case.
